(19) United States
(12) Patent Application Publication
(10) Pub. No.: US 2007/0097077 A1
(43) Pub. Date: May 3, 2007

(54) INPUT DEVICE FOR POINTING COORDINATES

(76) Inventors: Tadaaki ISHIKAWA, Tsuchiura (JP); Youichi Horii, Mitaka (JP); Takeshi Hoshino, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/552,586

(22) Filed: Oct. 25, 2006

(30) Foreign Application Priority Data
Oct. 28, 2005 (JP) 2005-314679

(51) Int. Cl. G09G 5/08

(52) U.S. Cl. 345/163

(57) ABSTRACT

Provided is a coordinate pointing device including a detecting unit for detecting movement of a main body of the coordinate pointing device, a signal processing unit for outputting a coordinate input signal based on information detected by the detecting unit, and a switching unit for switching a valid state in which the detecting unit detects the movement of the main body of the coordinate pointing device and an invalid state in which the detecting unit does not detect the movement of the main body.

### CLAIM OF PRIORITY

The present application claims priority from Japanese patent application 2005-314679 filed on Oct. 28, 2005, the content of which is hereby incorporated by reference into this application.

### BACKGROUND OF THE INVENTION

The present invention relates to a coordinate pointing device for inputting coordinates.

As coordinate pointing devices, there are various forms such as a mouse, a trackball, a touch panel, a touch pad, a digitizer, and a joy stick. However, nowadays, the mouse is generally used because the mouse is excellent in operability that allows a user to operate the mouse intuitively in moving the mouse, usability due to a size, weight, and the like of the mouse itself, simplicity of a structure, and durability.

The user moves the mouse on a plane by gripping a housing of the mouse with a hand. When the mouse is moved, a cursor on a screen of a host apparatus to which the mouse is connected moves.

As the mouse, a ball-type mouse shown in FIG. 33 and FIG. 35 and an optical mouse shown in FIG. 34 and FIG. 36 are generally known.

The ball-type mouse will be explained with reference to FIG. 33.

The ball-type mouse includes a housing 1, a detecting unit, a signal processing unit 9, and an interface unit.

The housing 1 has a size and a shape that make it easy for the user to grip the housing 1 with a hand. The housing 1 includes at least the detecting unit and the signal processing unit 9 in an inside thereof. The housing 1 has a bottom surface of a substantially planar shape opposed to a plane 7.

The housing 1 includes sliding portions 4 in the front (hereinafter, when the user grips the mouse with a hand, a finger tip side is assumed to be the front) of the bottom surface and the rear of the bottom surface. The sliding portions 4 are made of a material having a low coefficient of friction to make it easy to slide the ball-type mouse on the plane 7.

The detecting unit includes a ball 10 and a motion sensor 11.

A part of the ball 10 projects from a ball hole near the center of the bottom surface of the housing 1. When the user moves the ball-type mouse in a state in which the ball-type mouse is in contact with the plane 7, the ball 10 is rotated by friction against the plane 7.

The motion sensor 11 detects the movement of the mouse from the rotation of the ball 10. The motion sensor 11 detects the rotation of the ball 10 in two directions orthogonal to each other. Therefore, the motion sensor 11 includes rollers (not shown), which are in contact with the ball 10 and rotatable in association with the ball 10, in the two directions orthogonal to each other. The motion sensor 11 also includes a rotary encoder that detects the rotation of the respective rollers.

The rotary encoder detects the rotation of the rollers that rotate in association with the rotation of the ball 10, with the result that the detecting unit detects the movement of the ball-type mouse.

The signal processing unit 9 transmits a current position, an amount of movement, a moving direction, speed, and the like of the mouse to the interface unit as coordinate input information on the basis of information detected by the detecting unit 5.

The interface unit connects the mouse to the host apparatus. The interface unit may connect the mouse to the host apparatus by wire or by radio.

A select switch 8 is used in selecting a character, a link, or the like displayed on the screen.

The optical mouse will be explained with reference to FIG. 34.

The optical mouse includes a housing 1, a detecting unit 5, a signal processing unit 9, and an interface unit.

The housing 1 has a size and a shape that make it easy for the user to grip the housing 1 with a hand. The housing 1 includes at least the detecting unit 5 in the inside thereof. The housing 1 has a bottom surface of a substantially planar shape opposed to a plane 7.

The housing 1 includes sliding portions 4 in the front and the rear of the bottom surface. The sliding portions 4 are made of a material with a low coefficient of friction to make it easy to slide the optical mouse on the plane 7.

The detecting unit 5 includes a light emitting unit 5a and a light receiving unit 5b.

The light emitting unit 5a includes a light emitting element such as an LED and generates light 5c that is made incident on the plane 7. The light 5c is made obliquely incident on the plane 7 from a hole (not shown) provided in the bottom surface of the housing 1. The light 5c is irregularly reflected on the plane 7 to be reflected light 5d.

The light receiving unit 5b includes a light receiving hole (not shown) in which the reflected light 5d is made incident. When the reflected light 5d having appropriate intensity is made incident in the light receiving hole, the light receiving unit 5b reads the reflected light 5d. In other words, the light receiving unit 5b detects an amount of movement and a moving direction of the mouse. On the other hand, when the reflected light 5d having intensity lower than the appropriate intensity is made incident in the light receiving hole and when the reflected light 5d is not made incident in the light receiving hole, the light receiving unit 5b does not read the reflected light 5d. In other words, the light receiving unit 5b does not detect the amount of movement and the moving direction of the mouse.

The signal processing unit 9 transmits the current position, the amount of movement, the moving direction, the speed, and the like of the mouse to the interface unit as coordinate pointing information on the basis of information detected by the detecting unit 5.

The interface unit connects the mouse to the host apparatus. The interface unit may connect the mouse and the host apparatus by wire or by radio.

The select switch 8 is used in selecting a character, a link, or the like displayed on the screen.

The amount of movement, the moving direction, and the like of the mouse detected by the detecting unit 5 are calculated and displayed as a cursor in coordinates on the screen.

When the amount of movement of the cursor calculated from a movable range of the mouse is longer than a coordinate range displayed on the screen of the host apparatus, it is possible to specify given coordinates in an entire coordinate plane of the screen within the movable range of the mouse.

However, in actually using the mouse, when the user cannot secure a large movable range of the mouse, due to relative positional deviation of the cursor displayed on the screen from a position of the mouse, accuracy of coordinate resolution of the mouse, or the like, the movable range of the mouse is often narrower than the movable range of the cursor displayed on the screen of the host apparatus.

Under such circumstances, when the user moves the cursor displayed on the screen of the host apparatus in excess of the movable range of the mouse, the user moves the mouse to secure a movable range of the mouse anew in a state in which the detecting unit of the mouse does not detect movement of the mouse. After that, the user brings the mouse into a state in which the detecting unit can detect movement of the mouse, moves the mouse in the movable range, and moves the cursor displayed on the screen of the host apparatus (hereinafter, referred to as “move the mouse with lifting”).

When the mouse is the ball-type mouse and the optical mouse, a state in which the detecting unit of the mouse cannot detect movement of the mouse means a state in which the user lifts the mouse to allow the mouse to become apart from a contact surface as shown in FIG. 35 and FIG. 36.

Operation for moving the mouse with lifting makes it possible to move the mouse over an entire range on the screen of the host apparatus in a narrow movable range of the mouse. However, the user always has to lift the mouse.

### SUMMARY OF THE INVENTION

With conventional techniques as described above, it is difficult for people with a low degree of freedom of hands or fingers such as physically handicapped people and patients of tenosynovitis, in particular, people having difficulty in bending fingers or gripping an object to lift the mouse.

The operation for moving the mouse with lifting has poor operability because the mouse is lifted and brought into contact with the plane. Impact caused when the mouse comes into contact with the plane imposes burdens on a wrist and fingers of the user. Moreover, sound generated when the mouse comes into contact with the plane is a nuisance for the user.

It is also difficult for those who have difficulty in bending fingers to push the select switch of the usual mouse.

It is therefore an object of this invention to provide a coordinate pointing device that has high operability for people having a low degree of freedom of hands and fingers and provide a mouse that does not impose burdens on a wrist and fingers.

According to a representative aspect of this invention, this invention provides a coordinate pointing device including: a detecting unit for detecting movement of a main body of the coordinate pointing device; a signal processing unit for outputting a coordinate pointing signal based on information detected by the detecting unit; and switching means for switching a valid state in which the detecting unit detects the movement of the main body of the coordinate pointing device and an invalid state in which the detecting unit does not detect the movement of the main body.

According to this invention, it is possible to provide a coordinate pointing device that has high operability for people having a low degree of freedom of hands and fingers.

### BRIEF DESCRIPTION OF THE DRAWINGS

The present invention can be appreciated by the description which follows in conjunction with the following figures, wherein:

FIG. 1 is a sectional view at the time of an invalid state of a coordinate pointing device according to a first embodiment of this invention;

FIG. 2 is a sectional view at the time of a valid state of the coordinate pointing device according to the first embodiment;

FIG. 3 is a block diagram of the coordinate pointing device according to the first embodiment;

FIG. 4 is a sectional view at the time of an invalid state of a coordinate pointing device according to a second embodiment of this invention;

FIG. 5 is a sectional view at the time of a valid state of the coordinate pointing device according to the second embodiment;

FIG. 6 is a sectional view at the time of an invalid state of a coordinate pointing device according to a third embodiment of this invention;

FIG. 7 is a sectional view at the time of a valid state of the coordinate pointing device according to the third embodiment;

FIG. 8 is a sectional view at the time of an invalid state of a coordinate pointing device according to a fourth embodiment of this invention;

FIG. 9 is a sectional view at the time of a valid state of the coordinate pointing device according to the fourth embodiment;

FIG. 10 is a block diagram of the coordinate pointing device according to the fourth embodiment;

FIG. 11 is a sectional view at the time of an invalid state of a coordinate pointing device according to a fifth embodiment of this invention;

FIG. 12 is a sectional view at the time of a valid state of the coordinate pointing device according to the fifth embodiment;

FIG. 13 is a block diagram at the time of the invalid state of the coordinate pointing device according to the fifth embodiment;

FIG. 14 is a block diagram at the time of the valid state of the coordinate pointing device according to the fifth embodiment;

FIG. 15 is a sectional view at the time of a valid state of a coordinate pointing device according to a sixth embodiment of this invention;

FIG. 16 is a block diagram of the coordinate pointing device according to the sixth embodiment;

FIG. 17 is a sectional view at the time of an invalid state of a coordinate pointing device according to a seventh embodiment of this invention;

FIG. 18 is a sectional view at the time of a valid state of the coordinate pointing device according to the seventh embodiment;

FIG. 19 is a block diagram of the coordinate pointing device according to the seventh embodiment;

FIG. 20 is a sectional view at the time of an invalid state of a coordinate pointing device according to an eighth embodiment of this invention;

FIG. 21 is a sectional view at the time of a valid state of the coordinate pointing device according to the eighth embodiment;

FIG. 22 is a sectional view at the time of input of a select switch of the coordinate pointing device according to the eighth embodiment;

FIG. 23 is a block diagram of the coordinate pointing device according to the eighth embodiment;

FIG. 24 is a sectional view at the time of an invalid state of a coordinate pointing device according to a ninth embodiment of this invention;

FIG. 25 is a sectional view at the time of a valid state of the coordinate pointing device according to the ninth embodiment;

FIG. 26 is a sectional view at the time of input of a select switch of the coordinate pointing device according to the ninth embodiment;

FIG. 27 is a sectional view at the time of an invalid state of a coordinate pointing device according to a tenth embodiment of this invention;

FIG. 28 is a sectional view at the time of a valid state of the coordinate pointing device according to the tenth embodiment;

FIG. 29 is a sectional view at the time of input of a select switch of the coordinate pointing device according to the tenth embodiment;

FIG. 30 is a sectional view at the time of an invalid state of a coordinate pointing device according to an eleventh embodiment of this invention;

FIG. 31 is a sectional view at the time of a valid state of the coordinate pointing device according to the eleventh embodiment;

FIG. 32 is a sectional view at the time of input of a select switch of the coordinate pointing device according to the eleventh embodiment;

FIG. 33 is a sectional view of a conventional ball-type mouse;

FIG. 34 is a sectional view of a conventional optical mouse;

FIG. 35 is a diagram showing a “move the mouse with lifting” state of the conventional ball-type mouse; and

FIG. 36 is a diagram showing a “move the mouse with lifting” state of the conventional optical mouse.

### DETAILED DESCRIPTION OF THE PREFERRED EMBODIMENTS

### First Embodiment

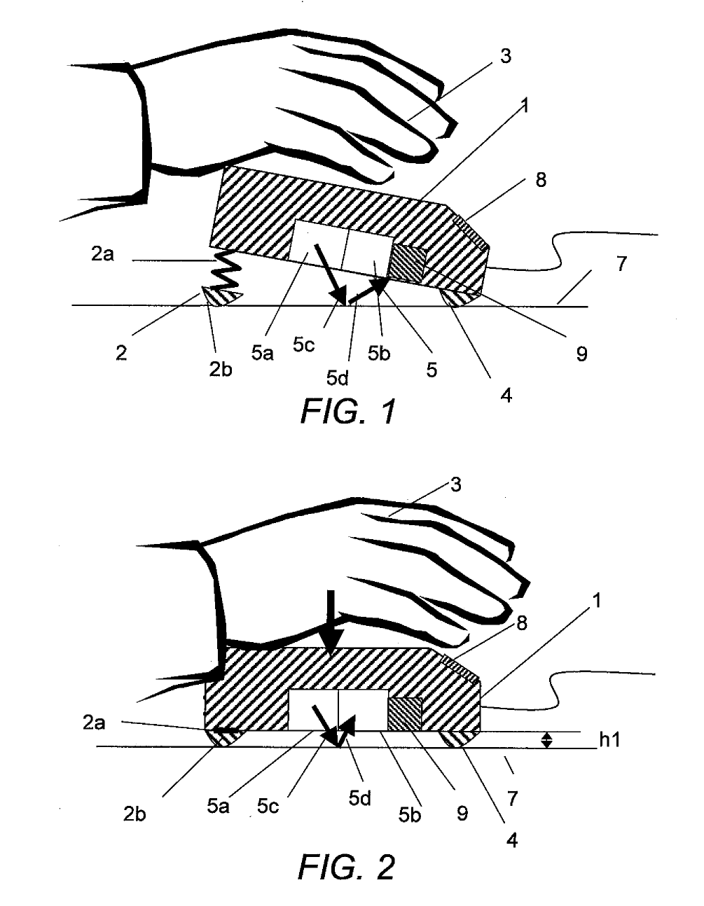

A first embodiment of this invention will be explained with reference to FIG. 1 to FIG. 3. In the first embodiment, a valid state and an invalid state of a detecting unit are switched by an elastic body in an optical mouse.

The optical mouse includes a housing 1, a detecting unit 5, a signal processing unit 9, and an interface unit.

The housing 1 has a size and a shape that make it easy for a user to grip the housing 1 with a hand. The housing 1 includes at least the detecting unit 5 in the inside thereof. The housing 1 has a bottom surface of a substantially planar shape opposed to a plane 7.

The housing 1 includes a sliding portion 4 in the front (hereinafter, when the user grips the mouse with a hand, a finger tip side is assumed to be the front) of the bottom surface. The housing 1 includes posture changing means 2 in the rear of the bottom surface. The posture changing means 2 includes a coil spring 2a, which is an elastic body, and a sliding portion 2b and changes position of housing 1 against the plane 7 when a pressure is added to the housing 1.

The coil spring 2a is provided between the bottom surface and the sliding portion 2b. The sliding portion 2b and the sliding portion 4 are made of a material having a low coefficient of friction to make it easy to slide the mouse on the plane 7. The coil spring 2a urges the rear of the mouse in a direction in which the rear of the mouse becomes apart from the plane 7 while the mouse is held in contact with the plane 7.

The detecting unit 5 includes a light emitting unit 5a and a light receiving unit 5b.

The light emitting unit 5a is constituted of an LED or the like and generates light 5c made incident on the plane 7. The light 5c is made obliquely incident on the plane 7 from a hole (not shown) provided in the bottom surface of the housing 1. The light 5c is irregularly reflected on the plane 7 to be reflected light 5d.

The light receiving unit 5b includes a light receiving hole (not shown) in which the reflected light 5d is made incident. When the reflected light 5d having appropriate intensity is made incident in the light receiving hole, the light receiving unit 5b reads the reflected light 5d. In other words, the light receiving unit 5b detects an amount of movement and a moving direction of the mouse. On the other hand, when the reflected light 5d having intensity lower than the appropriate intensity is made incident in the light receiving hole or when the reflected light 5d is not made incident in the light receiving hole, the light receiving unit 5b does not read the reflected light 5d. In other words, the light receiving unit 5b does not detect the amount of movement and the moving direction of the mouse.

The detecting unit 5 detects an amount of movement and a moving direction of the mouse when a distance between the bottom surface of the housing 1 and the place 7 is h1.

The signal processing unit 9 transmits a current position, an amount of movement, a moving direction, speed, and the like of the mouse to the interface unit as coordinate pointing information on the basis of information detected by the detecting unit 5.

The interface unit connects the mouse to the host apparatus. The interface unit may connect the mouse to the host apparatus by wire or by radio.

A select switch 8 is used in selecting a character, a link, or the like displayed on the screen.

As shown in FIG. 2, when a predetermined load is applied to the rear of the mouse by a hand 3, the coil spring 2a is compressed, the bottom surface and the plane 7 are made substantially parallel, and the distance between the bottom surface and the plane 7 is set to h1. Therefore, the mouse is located in a position where the reflected light 5d having appropriate intensity is made incident in the light receiving hole. The detecting unit 5 comes into the valid state in which the detecting unit 5 is capable of detecting movement of the mouse.

On the other hand, as shown in FIG. 1, when a load applied to the mouse is smaller than the predetermined load, the coil spring 2a is not completely compressed, the rear of the mouse is lifted by the coil spring 2a, and the distance between the bottom surface and the plane 7 is set to be equal to or larger than h1. Therefore, the detecting unit 5 comes into a state in which the reflected light 5d having intensity lower than the appropriate intensity is made incident in the light receiving hole or a state in which the reflected light 5d is not made incident in the light receiving hole. In other words, the detecting unit 5 comes into the invalid state in which the detecting unit 5 is incapable of detecting movement of the mouse.

The predetermined load with which the coil spring 2a is compressed and the detecting unit 5 changes from the invalid state to the valid state only has to be set to a load substantially equivalent to the own weight of the hand.

When the user applies the load substantially equivalent to the own weight of the hand to the mouse in this way, since the coil spring 2a is compressed and the detecting unit 5a comes into the valid state, the detecting unit 5 detects the movement of the mouse. On the other hand, when a load applied to the mouse is smaller than the own weight of the hand, since the coil spring 2a is not completely compressed and the detecting unit 5a comes into the invalid state, the detecting unit 5 does not detect movement of the mouse.

As described above, in the first embodiment, the detecting unit 5 can switch between the valid state and the invalid state according to whether the user applies the own weight of the hand to the mouse. This makes it unnecessary for the user to lift the mouse and move the mouse with lifting. Thus, it is possible to provide a mouse that has high operability for people with a low degree of freedom of hands and fingers. It is also possible to provide a mouse that does not impose burdens on a wrist and fingers.

It is preferable to use a touch sensor, an electrostatic switch, or a reflection optical switch as the select switch 8. Since this makes it unnecessary for the user to depress the switch with a finger, burdens on the user are reduced. In addition, operability for people with a low degree of freedom of fingers is improved.

It is also possible to use other elastic bodies such as a leaf spring instead of the coil spring 2a. In this embodiment, a rear of the bottom surface of the housing 1 is urged by the coil spring 2a in a direction in which the rear of the bottom surface becomes apart from the plane 7. However, the front or the sides of the bottom surface of the housing 1 may be urged by an elastic body in a direction in which the front or the sides of the bottom surface become apart from the plane 7.

### Second Embodiment

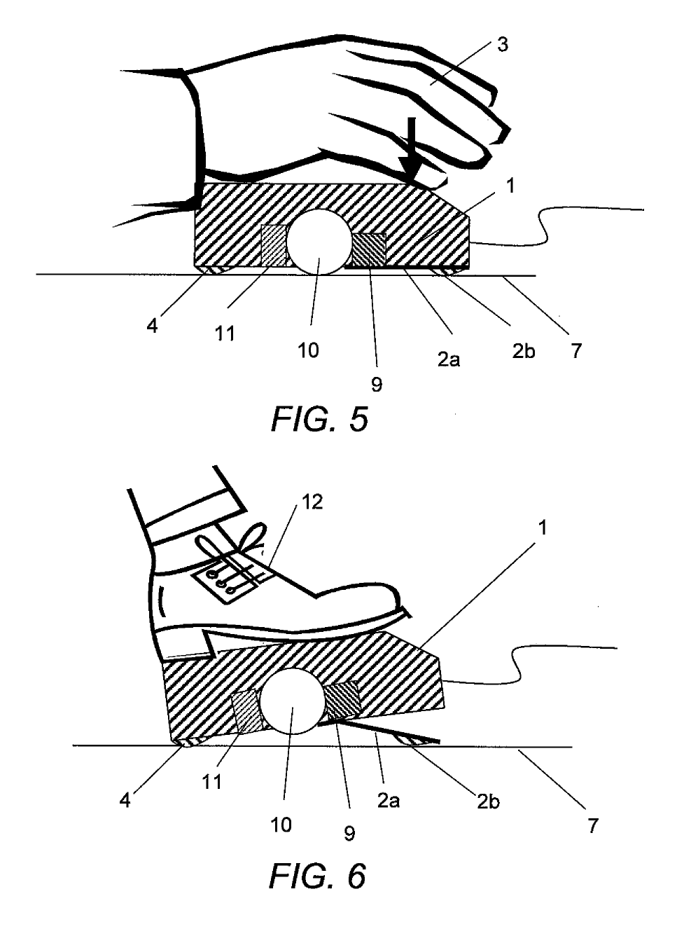

A second embodiment of this invention will be explained with reference to FIG. 4 and FIG. 5. In the second embodiment, a valid state and an invalid state of a detecting unit are switched by an elastic body in a boll-type mouse.

The ball-type mouse includes a housing 1, a detecting unit 5, a signal processing unit 9, and an interface unit.

The housing 1 has a size and a shape that make it easy for a user to grip the housing 1 with a hand. The housing 1 includes at least the detecting unit 5 and the signal processing unit 9 in the inside thereof. The housing 1 has a bottom surface of a substantially planar shape opposed to a plane 7.

The housing 1 includes a sliding portion 4 in the rear of the bottom surface. The housing 1 includes posture changing means 2 in the front of the bottom surface. The posture changing means 2 includes a leaf spring 2a, which is an elastic body, and a sliding portion 2b and changes position of housing 1 against the plane 7 when a pressure is added to the housing 1.

The coil spring 2a is provided between the bottom surface and the sliding portion 2b. The sliding portion 2b and the sliding portion 4 are made of a material having a low coefficient of friction to make it easy to slide the mouse on the plane 7. The coil spring 2a urges the front of the mouse in a direction in which the front of the mouse becomes apart from the plane 7 while the mouse is held in contact with the plane 7.

The detecting unit includes a ball 10 and a motion sensor 11.

A part of the ball 10 projects from a ball hole provided near the center of the bottom surface of the housing 1. When the user moves the ball-type mouse in a state in which the ball-type mouse is in contact with the plane 7, the ball 10 is rotated by friction against the plane 7.

The motion sensor 11 detects the movement of the mouse according to the rotation of the ball 10. The motion sensor 11 detects the rotation of the ball 10 in two directions orthogonal to each other. Therefore, the motion sensor 11 includes rollers (not shown) that are in contact with the ball 10 and rotate in association with the ball 10. The rollers are disposed in the two directions orthogonal to each other. The motion sensor 11 also includes a rotary encoder that is capable of detecting the rotation of the respective rollers.

Therefore, the rotary encoder detects the rotation of the rollers, which rotate in association with the ball 10, and the motion sensor 11 detects the movement of the ball-type mouse.

The signal processing unit 9 transmits a current position, an amount of movement, a moving direction, speed, and the like of the mouse to the interface unit as coordinate pointing information on the basis of information detected by the detecting unit.

The interface unit connects the mouse to the host apparatus. The interface unit may connect the mouse to the host apparatus by wire or by radio.

A select switch is used in selecting a character, a link, or the like displayed on the screen.

As shown in FIG. 4, when a predetermined load is applied to the front of the mouse by the hand 3, the leaf spring 2a is compressed and the ball 10 comes into contact with the plane 7. Therefore, since the ball rotates when the user moves the mouse, the motion sensor 11 detects the movement of the mouse. In other words, the detecting unit comes into the valid state.

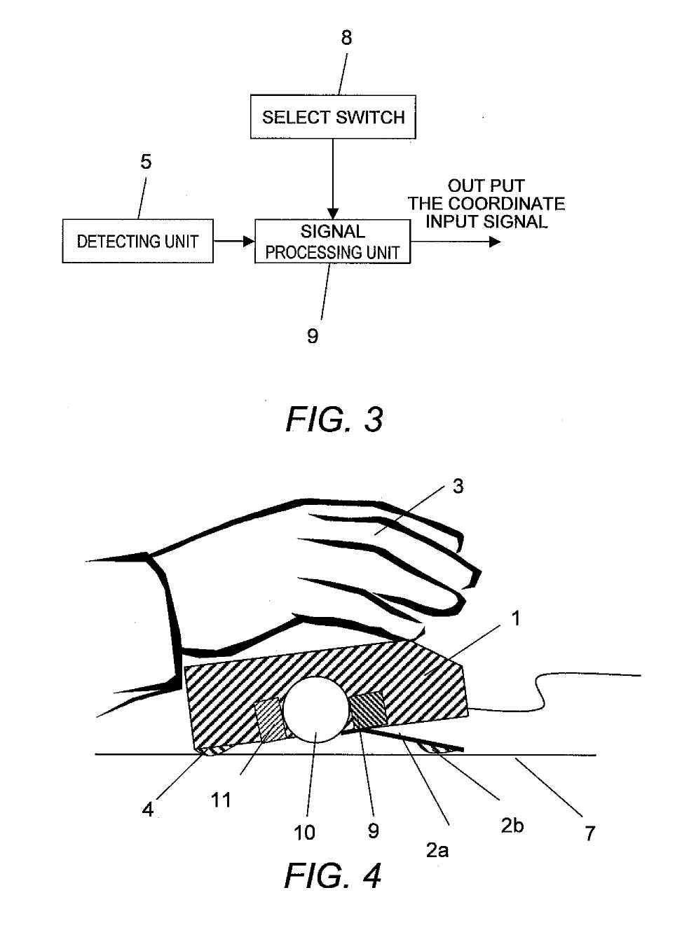

On the other hand, as shown in FIG. 3, when a load applied to the mouse is smaller than the predetermined load, the leaf spring 2a is not completely compressed and the front of the mouse is lifted by an urging force of the leaf spring 2a. Therefore, since the ball 10 does not come into contact with the plane 7, the ball does not rotate even if the user moves the mouse. The motion sensor 11 does not detect the movement of the mouse. In other words, the detecting unit comes into the invalid state.

The predetermined load with which the leaf spring 2a is compressed and the detecting unit changes from the invalid state to the valid state only has to be set to a load substantially equivalent to the own weight of the hand.

When the user applies the load substantially equivalent to the own weight of the hand to the mouse in this way, since the leaf spring 2a is compressed and the detecting unit comes into the valid state, the detecting unit detects the movement of the mouse. On the other hand, when a load applied to the mouse is smaller than the own weight of the hand, since the leaf spring 2a is not completely compressed and the detecting unit comes into the invalid state, the detecting unit does not detect the movement of the mouse.

In the second embodiment, the detecting unit can switch between the valid state and the invalid state according to whether the user applies the own weight of the hand to the mouse. This makes it unnecessary for the user to lift the mouse and move the mouse with lifting. Thus, it is possible to provide a mouse that has high operability for people with a low degree of freedom of hands and fingers. It is also possible to provide a mouse that does not impose burdens on a wrist and fingers.

The select switch may be provided in a position of the housing 1 where the select switch is operable by a finger. A touch sensor, an electrostatic switch, or a reflection optical switch is used as the select switch. Since this makes it unnecessary for the user to depress the switch with a finger, burdens on the user are reduced. In addition, operability for people with a low degree of freedom of fingers is improved.

It is also possible to use other elastic bodies such as a coil spring instead of the leaf spring 2a. In this embodiment, the front of the bottom surface of the housing 1 is urged by the leaf spring 2a in the direction in which the front of the bottom surface becomes apart from the plane 7. However, the rear or the sides of the bottom surface of the housing 1 may be urged by an elastic body in the direction in which the rear or the sides of the bottom surface become apart from the plane 7.

### Third Embodiment

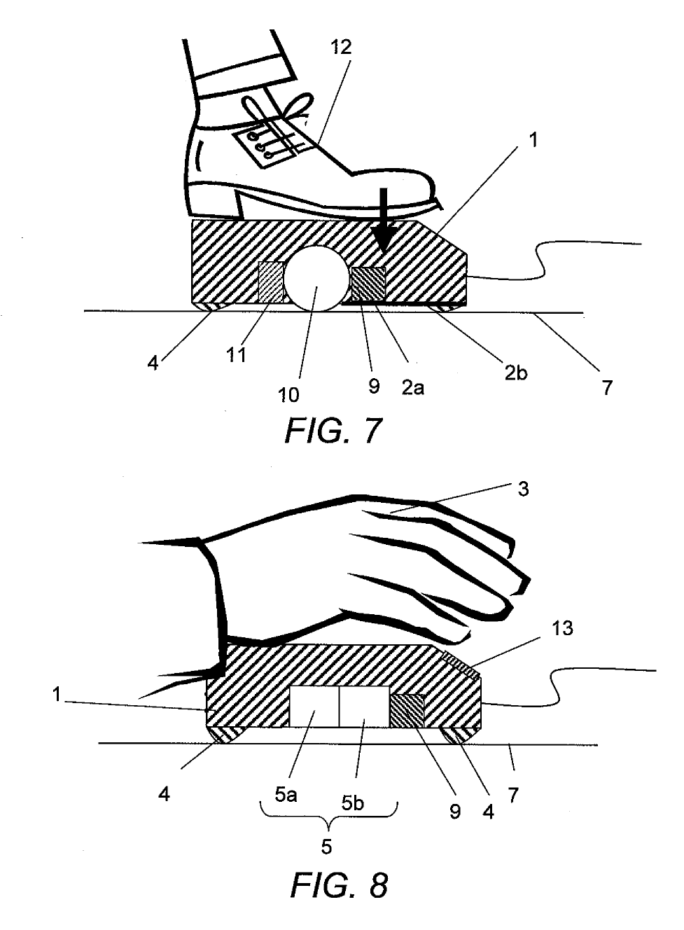

A third embodiment of this invention will be explained with reference to FIG. 6 and FIG. 7. In the third embodiment, a valid state and an invalid state of a detecting unit are switched by an elastic body in a foot mouse.

In the third embodiment, the mouse according to the second embodiment operated by the hand of the user is made operable by a foot 12 of the user. A structure according to the third embodiment is substantially identical with the structure according to the second embodiment. Components identical with those according to the second embodiment are denoted by the identical reference symbols and explanations thereof are omitted.

Since the user operates the mouse with the foot 12, the housing 1 has a size and a shape that make it easy for the user to operate the housing 1 with the foot 12.

As shown in FIG. 7, when a predetermined load is applied to the front of the ball-type mouse with a toe of the foot 12, the leaf spring 2a is compressed and the ball 10 comes into contact with the plane 7. Thus, when the user moves the ball-type mouse, the ball 10 rotates. Therefore, the motion sensor 11 detects the movement of the ball-type mouse. In other words, the detecting unit comes into the valid state.

On the other hand, when a load applied to the front of the ball-type mouse is smaller than the predetermined load, as shown in FIG. 6, the leaf spring 2a is not completely compressed and the front of the ball-type mouse is lifted by an urging force of the leaf spring 2a. Therefore, the ball 10 does not come into contact with the plane 7. Since the ball does not rotate even if the user moves the ball-type mouse, the motion sensor 11 does not detect the movement of the ball-type mouse. In other words, the detecting unit comes into the invalid state.

The predetermined load with which the leaf spring 2a is compressed and the detecting unit changes from the invalid state to the valid state only has to be set to a load substantially equivalent to the own weight of the foot 12.

When the user applies the load substantially equivalent to the own weight of the foot 12 to the ball-type mouse in this way, since the leaf spring 2a is compressed and the detecting unit comes into the valid state, the detecting unit detects the movement of the ball-type mouse. On the other hand, when a load applied to the ball-type mouse is smaller than the load substantially equivalent to the own weight of the foot 12, since the leaf spring 2a is not completely compressed and the detecting unit comes into the invalid state, the detecting unit does not detect the movement of the ball-type mouse.

In the third embodiment, it is possible to switch between the valid state and the invalid state of the detecting unit according to whether the user applies the own weight of the foot 12 to the ball-type mouse. Since the foot 12 cannot grip and lift the conventional foot mouse, the foot 12 cannot move the mouse with lifting. However, in this embodiment, it is possible to switch between the valid state and the invalid state of the detecting unit according to whether the own weight of the foot 12 is applied to the ball-type mouse. Thus, it is possible to move even a foot mouse on a screen of a host apparatus in excess of a movable range of the mouse.

It is also possible to use other elastic bodies such as a coil spring instead of the leaf spring 2a. In this embodiment, the front of the bottom surface of the housing 1 is urged by the leaf spring 2a in the direction in which the front of the bottom surface becomes apart from the plane 7. However, the rear or the sides of the bottom surface of the housing 1 may be urged by an elastic body in the direction in which the rear or the sides of the bottom surface become apart from the plane 7.

### Fourth Embodiment

A fourth embodiment of this invention will be explained with reference to FIG. 8 to FIG. 10. In the fourth embodiment, a power supply to a detecting unit is switched on and off by a cut off switch in an optical mouse. Components identical with those according to the first embodiment are denoted by the identical reference symbols and explanations thereof are omitted.

The housing 1 includes a cut off switch 13 in the front of the housing 1 and in a range in which the cut off switch 13 is operable by a finger. The cut off switch 13 switches a valid state and an invalid state of the detecting unit 5. The cut off switch 13 includes a switch or a sensor that is responsive to a slight touch such as a mechanical switch that operates even with a small pressing force, a touch sensor, an electrostatic sensor, or a reflection optical sensor that has a short detection distance.

As shown in FIG. 10, the cut off switch 13 is connected to the detecting unit 5. When the cut off switch 13 is on, the detecting unit 5 is connected to the power supply. Therefore, power is supplied to the detecting unit 5. The detecting unit 5 is in the valid state in which the detecting unit 5 can detect movement of the mouse. On the other hand, when the cut off switch 13 is off, the detecting unit 5 is not connected to the power supply. In other words, the supply of power to the detecting unit 5 is interrupted. Therefore, the light emitting unit 5a of the detecting unit 5 does not emit light. The detecting unit 5 is in the invalid state in which the detecting unit 5 cannot detect movement of the mouse.

As shown in FIG. 8, when the user does not touch the cut off switch 13, the cut off switch 13 is off and the supply of power to the detecting unit 5 is interrupted. Therefore, since the light emitting unit 5a does not emit light, even if the user moves the mouse, the detecting unit 5 cannot detect the movement of the mouse. In other words, the detecting unit 5 is in the invalid state in which the detecting unit 5 does not detect the movement of the mouse.

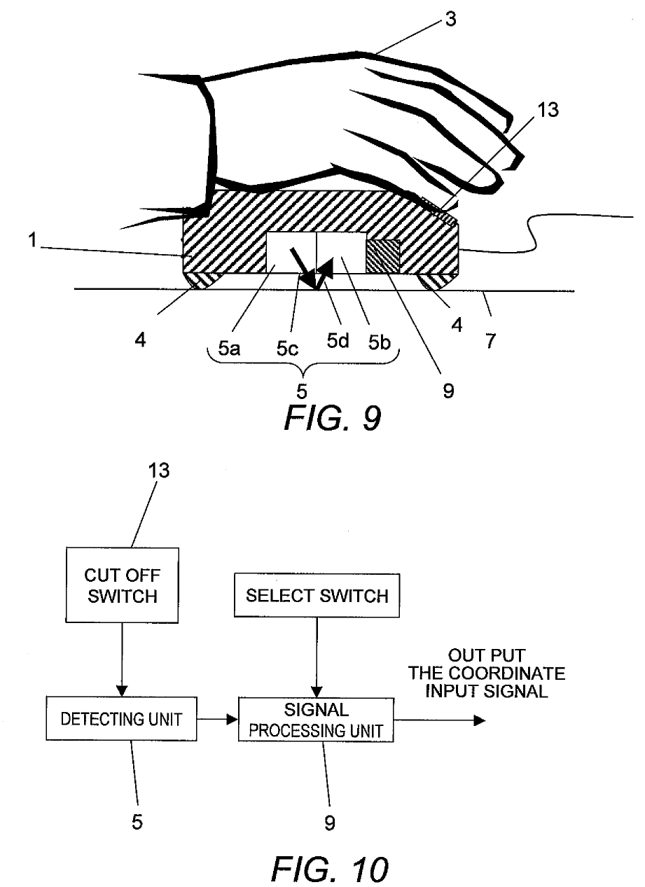

As shown in FIG. 9, when the user touches the cut off switch 13, the cut off switch 13 is on and power is supplied to the detecting unit 5. Therefore, the light emitting unit 5a emits the light 5c. The light 5c is irregularly reflected on the plane 7 to be the reflected light 5d. The light receiving unit 5b reads the reflected light 5d, whereby the detecting unit 5 detects the movement of the mouse. In other words, the detecting unit 5 is in the valid state in which the detecting unit 5 detects the movement of the mouse.

In the fourth embodiment, it is possible to switch between the valid state and the invalid state of the detecting unit 5 using the cut off switch 13. Since this makes it unnecessary for the user to lift the mouse and move the mouse with lifting, it is possible to provide a mouse that has high operability for people with a low degree of freedom of hands and fingers. It is also possible to provide a mouse that does not impose burdens on a wrist and fingers.

When the detecting unit 5 is in the invalid state, since the supply of power to the light emitting unit 5a is interrupted, it is possible to save power.

The supply of power to the detecting unit 5 is interrupted without interrupting the supply of power to the mouse by the cut off switch 13. This is because, if the supply of power to the mouse is interrupted, even connection of the power supply to the signal control unit 9 is interrupted. When the supply of power to the signal control unit 9 is stopped, the host apparatus does not recognize the mouse.

The supply of power to the light receiving unit 5b of the detecting unit 5 may be interrupted by the cut off switch 13.

Also in the ball-type mouse, it is possible to switch between supply of power and interruption of the supply of power to the motion sensor 11 that detects the movement of the mouse by detecting the rotation of the ball 10.

### Fifth Embodiment

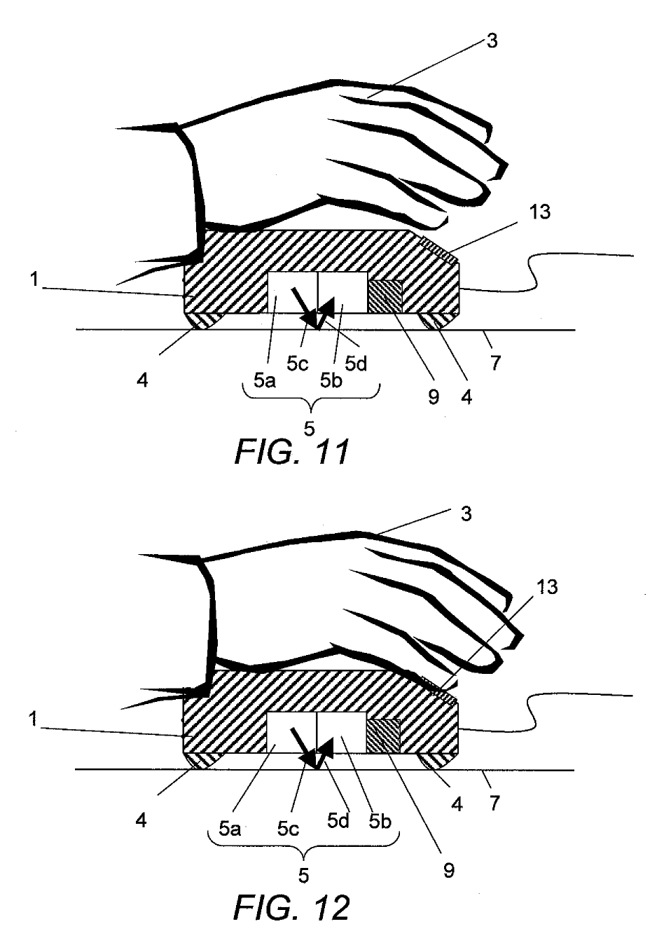

A fifth embodiment of this invention will be explained with reference to FIG. 11 to FIG. 14. In the fifth embodiment, in an optical mouse, signal connection between the detecting unit 5 and the signal processing unit 9 is switched by the cut off switch 13. The fifth embodiment is identical with the fourth embodiment except a structure of the cut off switch 13. Components identical with those according to the fourth embodiment are denoted by the identical reference symbols and explanations thereof are omitted.

The housing 1 includes a cut off switch 13 in the front of the housing 1 and in a range in which the cut off switch 13 is operable by a finger. The cut off switch 13 switches a valid state and an invalid state of the detecting unit 5. The cut off switch 13 includes a switch or a sensor that is responsive to a slight touch such as a mechanical switch that operates even with a small pressing force, a touch sensor, an electrostatic sensor, or a reflection optical sensor that has a short detection distance.

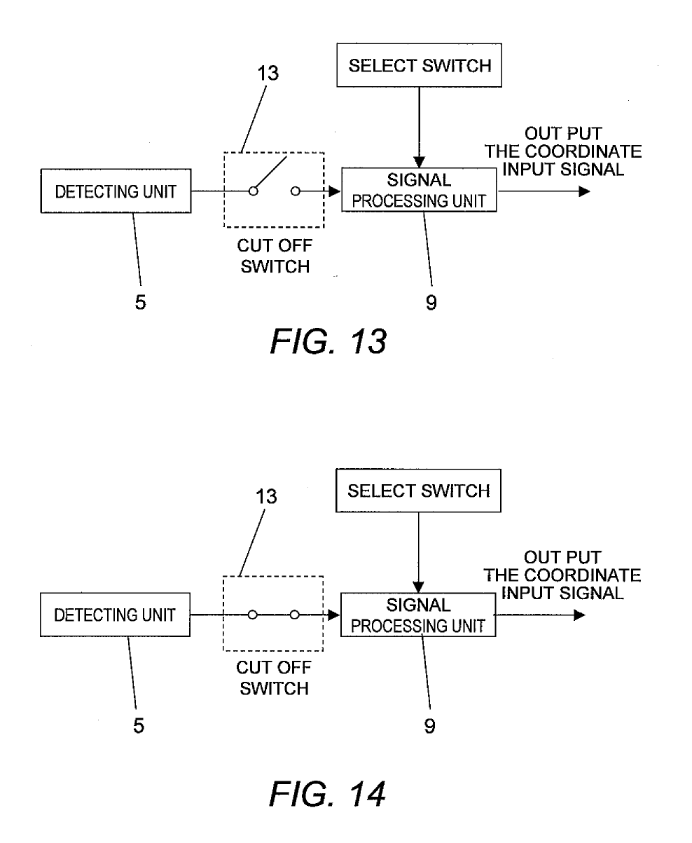

As shown in FIG. 13 and FIG. 14, the cut off switch 13 switches on and off of signal connection between the detecting unit 5 and the signal processing unit 9. As shown in FIG. 13, when the cut off switch 13 is off, the cut off switch 13 interrupts connection between the detecting unit 5 and the signal processing unit 9. On the other hand, as shown in FIG. 14, when the cut off switch 13 is on, the detecting unit 5 is connected to the signal processing unit 9 by the cut off switch 13.

As shown in FIG. 11, when the user does not touch the cut off switch 13, the cut off switch 13 is off. Therefore, as shown in FIG. 13, the cut off switch 13 interrupts connection between the detecting unit 5 and the signal processing unit 9. Therefore, even if the detecting unit 5 detects the movement of the mouse, since a detected signal does not reach the signal processing unit 9, the detecting unit 5 cannot detect the movement of the mouse. In other words, the detecting unit 5 is in an invalid state. As shown in FIG. 12, when the user touches the cut off switch 13, the cut off switch 13 is on. Therefore, the cut off switch 13 connects the detecting unit 5 to the signal processing unit 9. Since a detected signal reaches the signal processing unit 9, the detecting unit 5 detects the movement of the mouse. In other words, the detecting unit is in a valid state.

In the fifth embodiment, it is possible to switch between the valid state and the invalid state of the detecting unit 5 using the cut off switch 13. Since this makes it unnecessary for the user to lift the mouse and move the mouse with lifting, it is possible to provide a mouse that has high operability for people with a low degree of freedom of hands and fingers. It is also possible to provide a mouse that does not impose burdens on a wrist and fingers.

Even when the detecting unit 5 is in the invalid state, since the light emitting unit 5a emits the light 5c, the user does not have to wait for operation for a time required until the light 5c stabilizes.

The cut off switch 13 switches the valid state and the invalid state of the detecting unit 5 according to whether the detecting unit 5 is connected to the signal processing unit 9. Thus, it is possible to simplify a structure of an electric circuit.

In the ball-type mouse, it is also possible to detect the rotation of the ball 10 and switch a connection of a signal from the motion sensor 11, which detects the movement of the mouse, to the signal processing unit 9 using the cut off switch 13.

### Sixth Embodiment

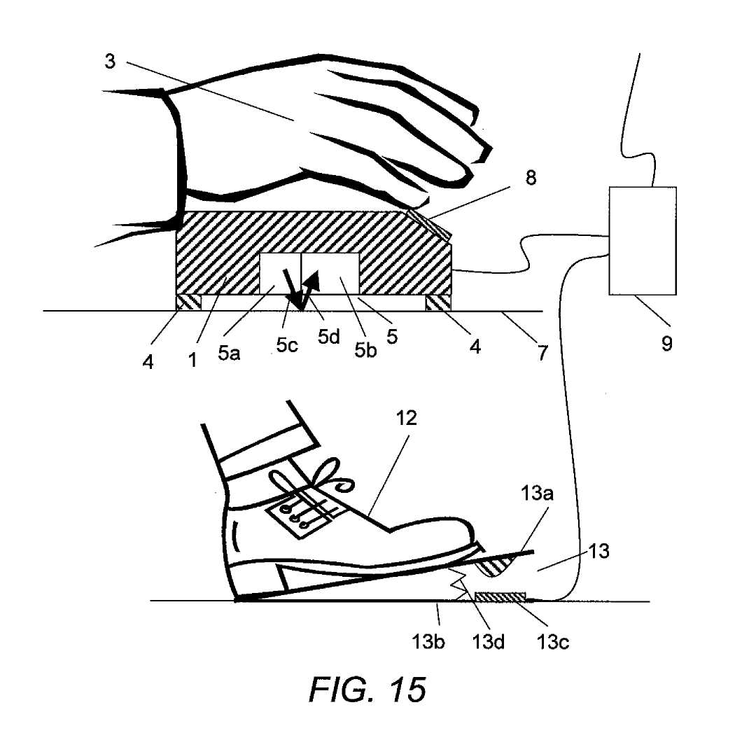

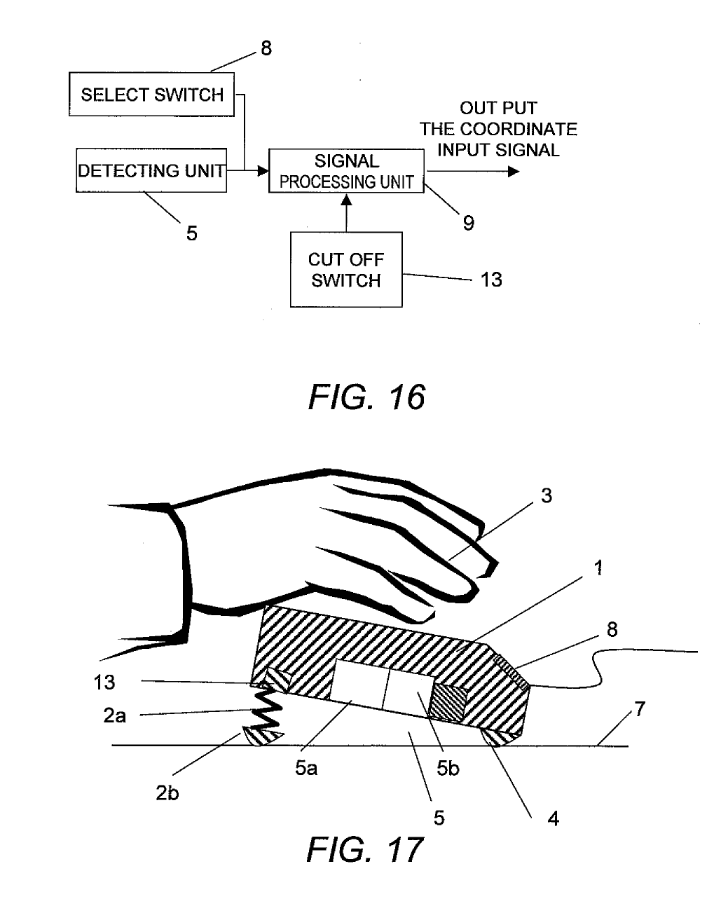

A sixth embodiment of this invention will be explained with reference to FIG. 15 and FIG. 16. In the sixth embodiment, the signal processing unit 9 outputs a stop signal using a cut off switch in an optical mouse. Components identical with those according to the first embodiment are denoted by the identical reference symbols and explanations thereof are omitted.

The cut off switch 13 is provided separately from the mouse. The cut off switch 13 is operable by the foot 12. The cut off switch 13 includes a pedal 13a, a base 13b, a contact switch 13c, and a coil spring 13d.

The pedal 13a is a member on which the foot 12 is placed. The base 13b includes the contact switch 13c. The coil spring 13d is provided between the pedal 13a and the base 13b. The coil spring 13d urges the pedal 13a in a direction in which the pedal 13a becomes apart from the base 13b.

As shown in FIG. 16, the cut off switch 13 is connected to the signal processing unit 9. As shown in FIG. 15, when the cut off switch 13 is off, the signal processing unit 9 outputs a stop signal to the interface unit rather than a detection signal from the detecting unit 5. Therefore, even if the detecting unit 5 detects the movement of the mouse, a detection signal is not outputted from the signal processing unit 9. In other words, since a detection signal from the detecting unit 5 is invalidated, the detecting unit 5 cannot detect the movement of the mouse. In other words, the detecting unit 5 is in an invalid state.

When the cut off switch 13 is off, the signal processing unit 9 also invalidates an input signal from the select switch 8. Therefore, even if the select switch 8 is operated when the cut off switch 13 is off, it is impossible to perform operation such as selection.

On the other hand, when the pedal 13a is stepped in against an urging force of the coil spring 13d by the foot 12 of the user, the contact switch 13c comes into contact with a part of the pedal 13a to turn on the cut off switch 13. When the cut off switch 13 is on, the signal processing unit 9 processes a signal detected by the detecting unit 5 as usual. Therefore, the detecting unit 5 detects the movement of the mouse. In other words, the detecting unit 5 is in a valid state.

In the sixth embodiment, it is possible to switch between the valid state and the invalid state of the detecting unit 5 using the cut off switch 13. This makes it unnecessary for the user to lift the mouse and move the mouse with lifting, so it is possible to provide a mouse that has high operability for people with a low degree of freedom of hands and fingers. It is also possible to provide a mouse that does not impose burdens on a wrist and fingers.

The cut off switch 13 is operated by the foot 12 of the user, so it is possible to reduce burdens on the wrist of the user.

It is possible to apply this embodiment to a ball-type mouse by providing the cut off switch 13 operable by the foot in the ball-type mouse and adopting the same structure as the signal processing unit 9.

### Seventh Embodiment

A seventh embodiment of this invention will be explained with reference to FIG. 17 to FIG. 19. In the seventh embodiment, when the mouse is located in a position where the reflected light 5d having appropriate intensity is made incident in the light receiving hole, power is supplied to the detecting unit 5 by the cut off switch 13 to bring the detecting unit 5 into a valid state. Components identical with those according to the first embodiment are denoted by the identical reference symbols and explanations thereof are omitted.

The housing 1 includes the posture changing means 2 in the rear of the bottom surface. The posture changing means 2 includes the coil spring 2a, which is an elastic body, and the sliding portion 2b.

The coil spring 2a is provided between the bottom surface and the sliding portion 2b. The sliding portion 4 is made of a material having a low coefficient of friction to make it easy to slide the mouse on the plane 7. The housing 1 also includes the sliding portion 4 made of a material having a low coefficient of friction in the front of the bottom surface. The coil spring 2a urges the mouse in a direction in which the mouse becomes apart from the plane 7 while being held in contact with the plane 7.

The housing 1 includes the cut off switch 13 in the rear thereof. The cut off switch 13 includes a push button switch.

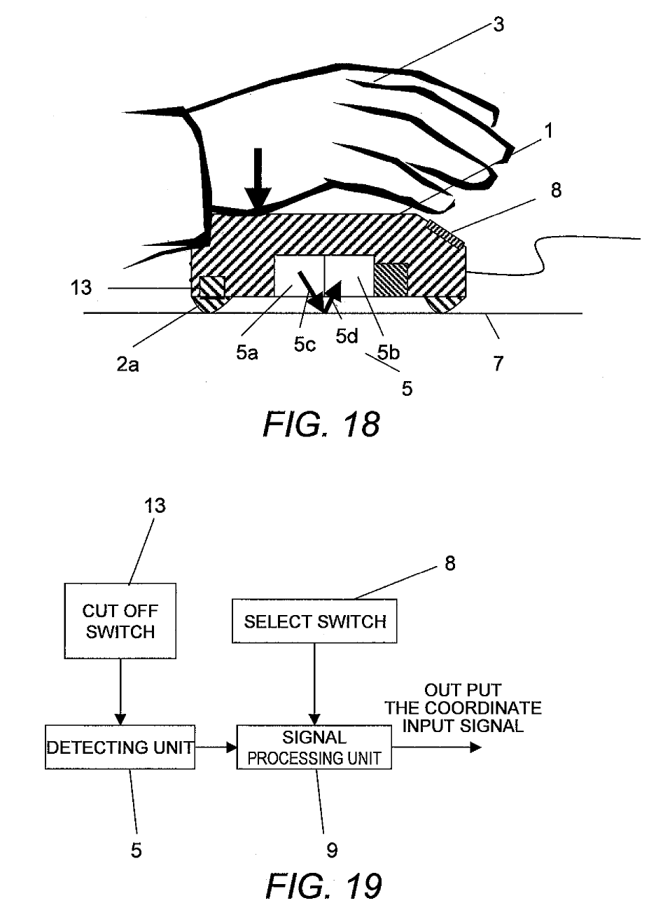

As shown in FIG. 18, when a predetermined load is applied to the rear of the mouse by the hand 3, the coil spring 2a is compressed, the bottom surface and the plane 7 are made substantially parallel, the distance between the bottom surface and the plane 7 is set to h1, and the mouse is located in a position where the reflected light 5d having appropriate intensity can be made incident in the light receiving hole. When the coil spring 2a is compressed, the push button switch is pressed by the sliding portion 2b to turn on the cut off switch 13. As the cut off switch 13 is turned on, the detecting unit 5 is connected to the power supply and power is supplied to the detecting unit 5. Therefore, the reflected light 5d having appropriate intensity is made incident in the light receiving hole and the detecting unit 5 comes into the valid state in which the detecting unit 5 is capable of detecting the movement of the mouse.

On the other hand, as shown in FIG. 17, when a load applied to the coil spring 2a is smaller than the predetermined load, the coil spring 2a is not completely compressed and the rear of the mouse is lifted by the coil spring 2a. In this state, the cut off switch 13 is off, the power supply is not connected to the detecting unit 5, and the supply of power to the detecting unit 5 is interrupted. Therefore, since the light emitting unit 5a does not emit light, even if the user moves the mouse, the detecting unit 5 cannot detect the movement of the mouse. In other words, the detecting unit 5 is in an invalid state.

The predetermined load with which the coil spring 2a is compressed and the detecting unit 5 changes from the invalid state to the valid state only has to be set to a load substantially equivalent to the own weight of the hand.

In the seventh embodiment, it is possible to switch between the valid state and the invalid state of the detecting unit 5 according to on and off of the cut off switch 13, that is, whether the own weight of the hand of the user is applied to the mouse. This makes it unnecessary for the user to lift the mouse and move the mouse with lifting, so it is possible to provide a mouse that has high operability for people with a low degree of freedom of hands and fingers. It is also possible to provide a mouse that does not impose burdens on a wrist and fingers.

When the detecting unit 5 is in the invalid state, power is not supplied to the detecting unit 5, so it is possible to save power.

Only when the mouse is located in a position where the light 5c is reflected on the plane and made incident on the light receiving unit, the cut off switch 13 is on. Thus, the mouse moves following operation of the select switch 8. It is possible to surely prevent a misoperation for selecting a wrong place.

The supply of power to the light receiving unit 5b of the detecting unit 5 may be interrupted by the cut off switch 13.

It is also possible to apply this embodiment to a ball-type mouse by supplying power to the motion sensor 11, which detects the rotation of the ball 10 and detects the movement of the mouse, using the cut off switch 13 when the mouse is located in a position where the reflected light 5d having appropriate intensity is made incident in the light receiving hole.

It is possible to use other elastic bodies such as a leaf spring instead of the coil spring 2a. In this embodiment, the rear of the bottom surface of the housing 1 is urged in the direction in which the rear of the bottom surface becomes apart from the plane 7 by the coil spring 2a. However, the front or the sides of the bottom surface of the housing 1 may be urged in the direction in which the front or the sides of the bottom surface become apart from the plane 7.

### Eighth Embodiment

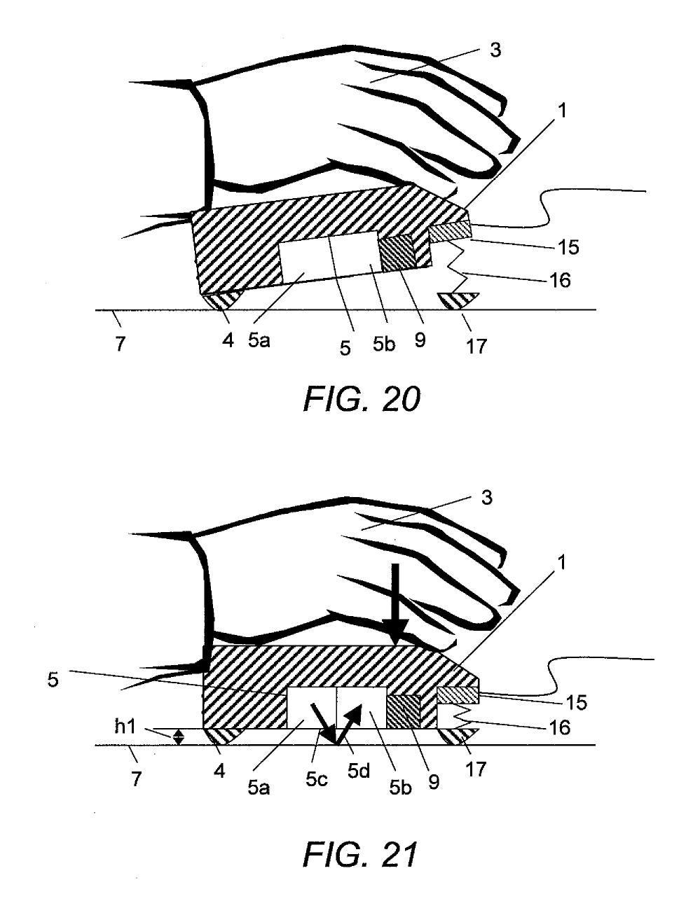

An eighth embodiment of this invention will be explained with reference to FIG. 20 to FIG. 23. In the eighth embodiment, in an optical mouse, when a first predetermined load substantially equivalent to the own weight of the hand is applied to the mouse by an elastic body, the mouse is located in a position where the reflected light 5d having appropriate intensity is made incident in the light receiving hole and power is supplied to the detecting unit 5 by the cut off switch 13 to bring the detecting unit 5 into a valid state. Moreover, when a second predetermined load larger than the first predetermined load is applied to the mouse, the elastic body is further compressed and the select switch is operated. Components identical with those according to the first embodiment are denoted by the identical reference symbols and explanations thereof are omitted.

The housing 1 has, in the front thereof, a cutoff unit obtained by cutting off a part of the housing 1. The cutoff unit includes a two-stage switch 15. A sliding portion 17 and the sliding portion 4 are made of a material having a low coefficient of friction. The sliding portion 17 is provided on a surface on the plane 7 side of the two-stage switch 15 via a coil spring 16. The coil spring 16 urges the mouse in the direction in which the mouse becomes apart from the plane 7 while being held in contact with the plane 7.

The two-stage switch 15 serves as both the cut off switch 13 and the select switch 8. The cut off switch 13 switches the detecting unit 5 to a valid state and an invalid state. The select switch 8 is used in selecting a character, a link, or the like displayed on the screen.

To be specific, the two-stage switch 15 has two contacts that are switched by a load applied to the two-stage switch 15. A first contact is the cut off switch 13. The first contact is turned on when a predetermined first predetermined load is applied thereto. As shown in FIG. 23, the first contact is connected to the detecting unit 5. When the first contact is on, the power supply is connected to the detecting unit 5 and power is supplied to the detecting unit 5. When the first contact is off, the detecting unit 5 is not connected to the power supply and the supply of power to the detecting unit 5 is interrupted.

A second contact is the select switch 8. The second contact is turned on when a predetermined second predetermined load larger than the first predetermined load, with which the first contact operates, is applied to the second contact. As shown in FIG. 23, the second contact is connected to the signal processing unit 9. When the second contact is on, the signal processing unit 9 detects operation of the select switch 8. When the second contact is off, the signal processing unit 9 does not detect operation of the select switch 8.

As shown in FIG. 20, when a load applied to the mouse is smaller than the first predetermined load, the coil spring 16 is not completely compressed and the front of the mouse is lifted by the coil spring 16. In this state, the cut off switch 13 of the two-stage switch 15 is off and the supply of power to the detecting unit 5 is interrupted. Therefore, the light emitting unit 5a does not emit light, so even if the user moves the mouse, the detecting unit 5 cannot detect the movement of the mouse. In other words, the detecting unit 5 is in the invalid state. The select switch 8 of the two-stage switch 15 is off and operation of the select switch 8 is not detected.

As shown in FIG. 21, when a load applied to the mouse is larger than the first predetermined load and smaller than the second predetermined load, the coil spring 16 is compressed, the bottom surface of the housing 1 is made substantially parallel to the plane 7, the distance between the bottom surface and the plane 7 is set to h1, and the mouse is located in a position where the reflected light 5d having appropriate intensity is made incident in the light receiving hole. The cut off switch 13 of the two-stage switch 15 is turned on. The detecting unit 5 is connected to the power supply and power is supplied to the detecting unit 5. Therefore, the reflected light 5d having appropriate intensity is made incident in the light receiving hole and the detecting unit 5 comes into the valid state in which the detecting unit 5 detects the movement of the mouse. The select switch 8 of the two-stage switch 15 is off and operation of the select switch 8 is not detected.

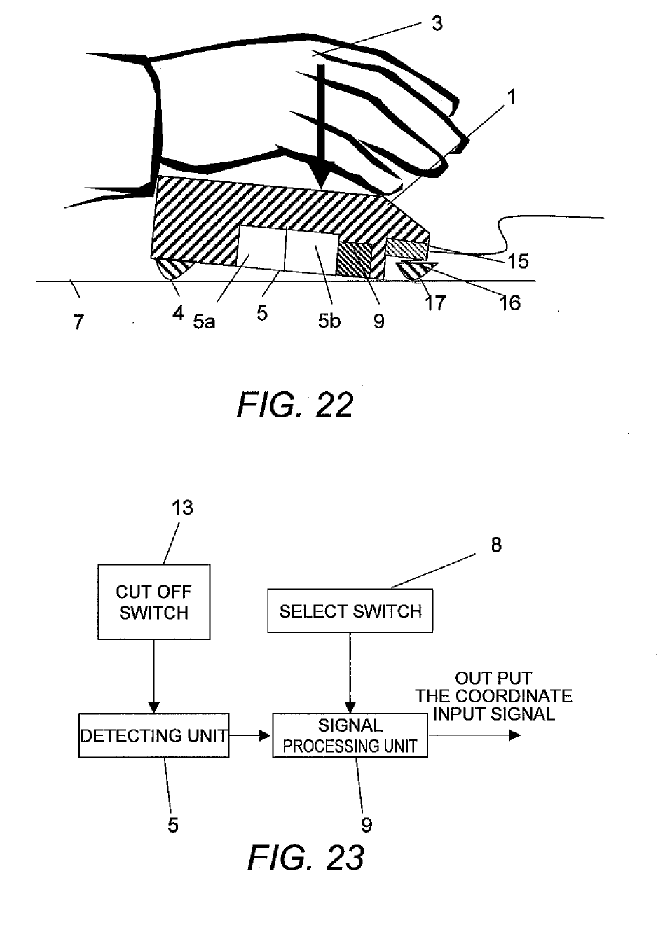

As shown in FIG. 22, when a load applied to the mouse is larger than the second predetermined load, the coil spring 16 is further compressed and the mouse inclines forward. In other words, the bottom surface of the housing 1 inclines to the front of the mouse with respect to the plane 7. In this state, the cut off switch 13 of the two-stage switch 15 is off and the supply of power to the detecting unit 5 is interrupted. Therefore, the light emitting unit 5a does not emit light, so even if the user moves the mouse, the detecting unit 5 cannot detect the movement of the mouse. In other words, the detecting unit 5 is in the invalid state. The second contact is on, so the signal processing unit 9 recognizes that the select switch 8 is operated.

The first predetermined load with which the cut off switch 13 of the two-stage switch 15 is turned on only has to be set to a load substantially equivalent to the own weight of the hand. The second predetermined load with which the select switch 8 of the two-stage switch 15 is turned on only has to be set to a predetermined load larger than the own weight of the hand.

In the eighth embodiment, it is possible to switch between the valid state and the invalid state of the detecting unit 5 according to on and off of the cut off switch 13 of the two-stage switch 15, that is, whether the own weight of the hand of the user is applied to the mouse. This makes it unnecessary for the user to lift the mouse and move the mouse with lifting, so it is possible to provide a mouse that has high operability for people with a low degree of freedom of hands and fingers. It is also possible to provide a mouse that does not impose burdens on a wrist and fingers.

When the detecting unit 5 is in the invalid state, power is not supplied to the detecting unit 5, so it is possible to save power.

The supply of power to the light receiving unit 5b of the detecting unit 5 may be interrupted by the cut off switch 13.

Moreover, when the switch of the second contact of the two-stage switch 15 is turned on and off, or the predetermined load larger than the own weight of the hand of the user is applied to the mouse, the select switch is inputted. Thus, it is possible to provide a mouse that has high operability for people with a low degree of freedom of hands and fingers. It is also possible to provide a mouse that does not impose burdens on a wrist and fingers.

When the select switch is inputted, or the second contact is on, the detecting unit 5 is in the invalid state, so even if the mouse moves following operation of the select switch 8, it is possible to prevent a misoperation for selecting a wrong place.

### Ninth Embodiment

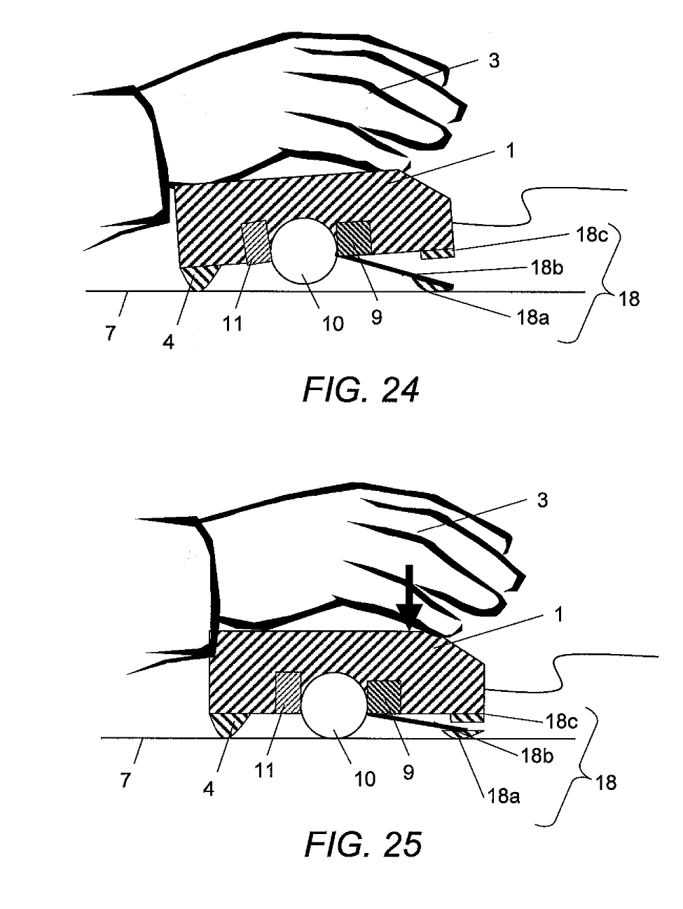

A ninth embodiment of this invention will be explained with reference to FIG. 24 to FIG. 26. In the ninth embodiment, in a ball-type mouse, a valid state and an invalid state of a detecting unit are switched by an elastic body to make it possible to input the select switch 8 according to a load applied to the mouse. Components identical with those according to the second embodiment are denoted by the identical reference symbols and explanations thereof are omitted.

The housing 1 includes a select switch 18c in the front of the bottom surface thereof. The housing 1 includes a sliding portion 18a in the front of the bottom surface thereof via a leaf spring 18b. The leaf spring 18b urges the mouse in the direction in which the mouse becomes apart from the plane 7 while being held in contact with the plane 7.

The select switch 18c includes a push button switch. The select switch 18c is used in selecting a character, a link, or the like displayed on the screen. The leaf spring 18b is compressed to a degree at which the ball 10 is brought into contact with the plane 7 by a load substantially equivalent to the own weight of the hand 3. When a predetermined load larger than the own weight of the hand is applied to the select switch 18c, the leaf spring 18b is compressed and the sliding portion 18a presses the push button of the select switch 18c to turn on the select switch 18c. The select switch 18c is connected to the signal processing unit 9.

As shown in FIG. 24, when a load applied to the mouse is smaller than the own weight of the hand 3, the leaf spring 18b is not compressed and the ball 10 does not come into contact with the plane 7. Thus, the detecting unit does not detect the movement of the mouse. In other words, the detecting unit is in the invalid state. The push button of the select switch 18c and the sliding portion 18a are spaced apart from each other, so the select switch 18c is off and operation of the select switch 18c is not detected.

As shown in FIG. 25, when a load substantially equivalent to the own weight of the hand 3 is applied to the mouse, the leaf spring 18b is compressed and the ball 10 comes into contact with the plane 7. Therefore, the movement of the mouse allows the ball 10 to rotate and the detecting unit can detect the movement of the mouse. In other words, the detecting unit is in the valid state. Since the push button of the select switch 18c and the sliding portion 18a are apart from each other, the select switch 18c is off and operation of the select switch 18c is not detected.

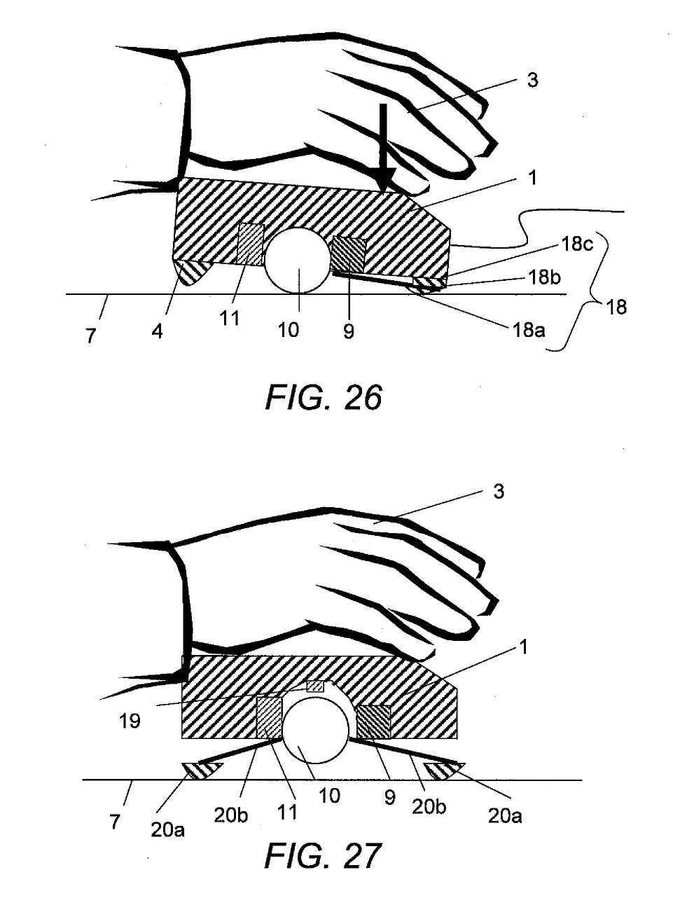

As shown in FIG. 26, when the predetermined load larger than the own weight of the hand 3 is applied to the mouse, the leaf spring 2a is further compressed. The bottom surface of the housing 1, that is, the mouse inclines to the front side and the ball 10 comes into contact with the plane 7. Therefore, the movement of the mouse allows the ball 10 to rotate and the detecting unit can detect the movement of the mouse. In other words, the detecting unit is in the valid state. Since the push button of the select switch 18c is pressed by the sliding portion 18a, the select switch 18c is on and operation of the select switch 18c is detected.

In the ninth embodiment, it is possible to switch between the valid state and the invalid state of the detecting unit according to whether the own weight of the hand of the user is applied to the mouse. This makes it unnecessary for the user to lift the mouse and move the mouse with lifting, so it is possible to provide a mouse that has high operability for people with a low degree of freedom of hands and fingers. It is also possible to provide a mouse that does not impose burdens on a wrist and fingers.

When the predetermined load larger than the own weight of the hand of the user is applied to the mouse, the select switch 18c is inputted. Thus, it is possible to provide a mouse that has high operability for people with a low degree of freedom of hands and fingers. It is also possible to provide a mouse that does not impose burdens on a wrist and fingers.

### Tenth Embodiment

A tenth embodiment of this invention will be explained with reference to FIG. 27 to FIG. 29. In the tenth embodiment, in a ball-type mouse, a detecting unit is brought into a valid state by a load applied to the mouse to make it possible to input the select switch 19. Components identical with those according to the second embodiment are denoted by the identical reference symbols and explanations thereof are omitted.

The housing 1 includes leaf springs 20b in the front and the rear of the bottom surface thereof. The housing 1 includes sliding portions 20a in the front and the rear of the bottom surface via the leaf springs 20b. The leaf springs 20b urge the mouse in the direction in which the mouse becomes apart from the plane 7 while being held in contact with the plane 7.

The housing 1 includes a ball storing unit capable of storing a ball in a state in which a part of the ball 10 is allowed to project from the bottom surface of the housing 1. The ball storing unit includes the select switch 19. The select switch 19 includes a push button switch. The select switch 19 is used in selecting a character, a link, or the like displayed on the screen. As the push button of the select switch 19 is pressed by the ball 10, the select switch 19 is turned on. A contact unit of the select switch 19, which comes into contact with the ball 10, is made of a material having a low coefficient of friction. The select switch 19 is connected to the signal processing unit 9.

As shown in FIG. 27, when a load applied to the mouse is smaller than the own weight of the hand 3, the leaf spring 20b is not compressed and the ball 10 does not come into contact with the plane 7. Thus, the detecting unit does not detect the movement of the mouse. In other words, the detecting unit is in the invalid state. Since the push button of the select switch 19 and the ball 10 are spaced apart from each other, the select switch 19 is off and operation of the select switch 19 is not detected.

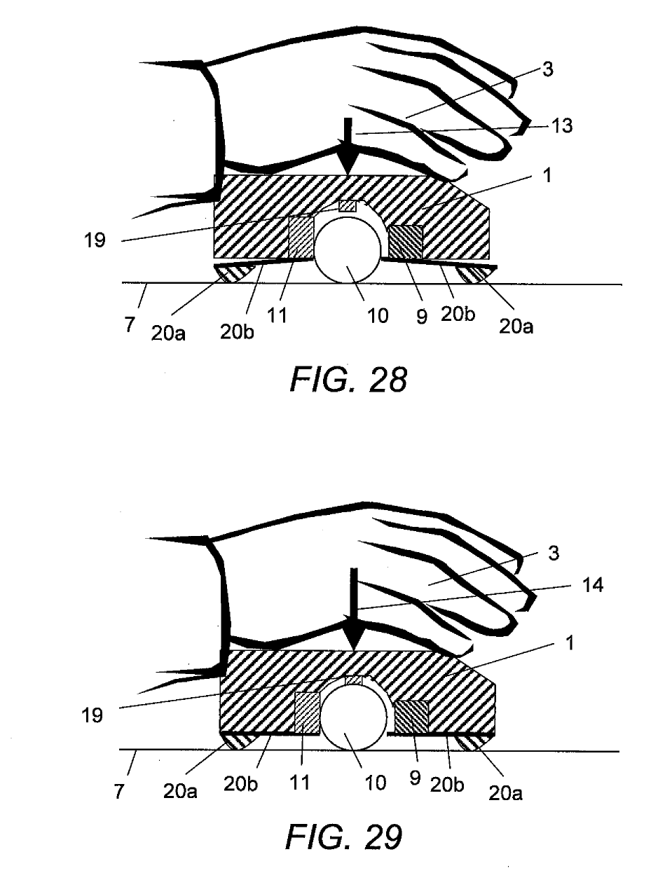

As shown in FIG. 28, when a load substantially equivalent to the own weight of the hand 3 is applied to the mouse, the leaf spring 20b is compressed and the ball 10 comes into contact with the plane 7. Therefore, the movement of the mouse allows the ball 10 to rotate and the detecting unit can detect the movement of the mouse. In other words, the detecting unit is in the valid state. The push button of the select switch 19 and the ball 10 are apart from each other, so the select switch 19 is off and operation of the select switch 19 is not detected.

As shown in FIG. 29, when the predetermined load larger than the own weight of the hand 3 is applied to the mouse, the leaf spring 20b is further compressed. The ball 10 then comes into contact with the plane 7. Therefore, the movement of the mouse allows the ball 10 to rotate and the detecting unit can detect the movement of the mouse. In other words, the detecting unit is in the valid state. The select switch 19 is pressed by the ball 10, so the select switch 19 is on and operation of the select switch 18c is detected.

Moreover, even when the select switch 19 is on, or the ball 10 is in contact with the select switch 19, the contact unit of the select switch 19 with the ball 10 is made of the material having a low coefficient of friction, so the ball 10 is capable of rotating because of the friction against the plane 7. Therefore, even at the time of operation of the select switch 19, the detecting unit is in the valid state, so it is possible to perform operation of so-called click-and-drag.

In the tenth embodiment, it is possible to switch between the valid state and the invalid state of the detecting unit according to whether the own weight of the hand of the user is applied to the mouse. This makes it unnecessary for the user to lift the mouse and move the mouse with lifting. Thus, it is possible to provide a mouse that has high operability for people with a low degree of freedom of hands and fingers. It is also possible to provide a mouse that does not impose burdens on a wrist and fingers.

When the predetermined load larger than the own weight of the hand of the user is applied to the mouse, the select switch 19 is inputted. Thus, it is possible to provide a mouse that has high operability for people with a low degree of freedom of hands and fingers. It is also possible to provide a mouse that does not impose burdens on a wrist and fingers.

### Eleventh Embodiment

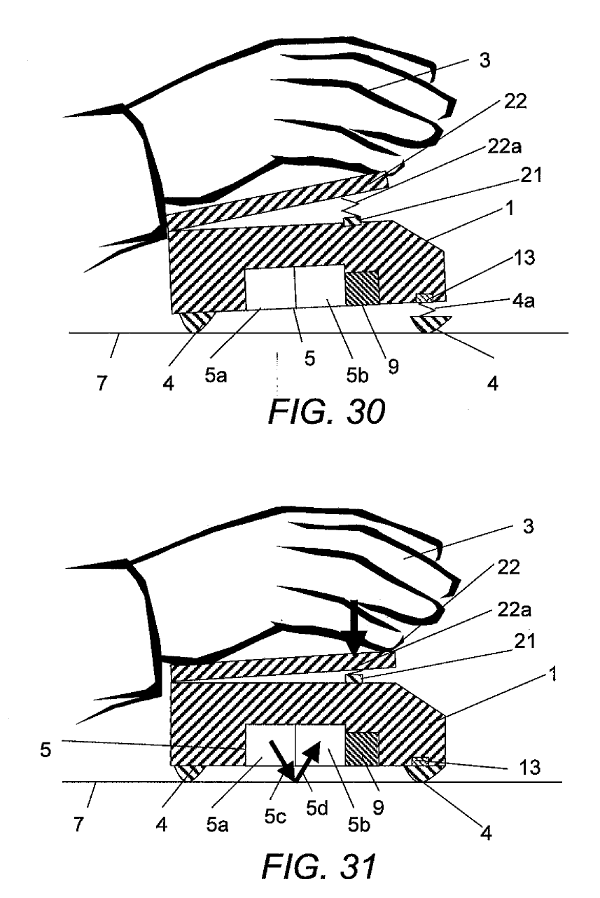

An eleventh embodiment of this invention will be explained with reference to FIG. 30 to FIG. 32. In the eleventh embodiment, in an optical mouse, a detecting unit is brought into a valid state by a load applied to the mouse to make it possible to operate the select switch 19. Components identical with those according to the first embodiment are denoted by the identical reference symbols and explanations thereof are omitted.

The housing 1 includes the cut off switch 13 in the front of the bottom surface thereof. The cut off switch 13 switches a valid state and an invalid state of the detecting unit 5. The housing 1 includes the sliding portion 4 and a coil spring 4a in the front of the bottom surface. The sliding portion 4 is provided in the cut off switch 13 via the coil spring 4a. The coil spring 4a urges the mouse in the direction in which the mouse becomes apart from the plane 7 while being held in contact with the plane 7.

The cut off switch 13 includes a push button switch. When a predetermined first predetermined load is applied to the cut off switch 13, the coil spring 4a is compressed and the sliding portion 4 presses the push button of the cut off switch 13 to turn on the cut off switch 13. When the cut off switch 13 is on, the detecting unit 5 is connected to the power supply. When the cut off switch 13 is off, the detecting unit 5 is not connected to the power supply.

On the other hand, the housing 1 includes a select switch 21 in the front of a top surface on the opposite side of the bottom surface. The select switch 21 is used in selecting a character, a link, or the like displayed on the screen. The housing 1 includes a hand rest 22, on which the hand 3 of the user is placed, at the rear end of the top surface. The hand rest 22 is provided on the top surface of the housing 1 so as to be rotatable. A coil spring 22a is provided between the hand rest 22 and the select switch 21. The coil spring 22a urges the hand rest 22 in a direction in which the hand rest 22 becomes apart from the top surface of the housing 1.

The select switch 21 includes a push button switch. When a second predetermined load larger than the first predetermined load is applied to the select switch 21, the coil spring 22a is compressed and the hand rest 22 presses the push button of the select switch 21 to turn on the select switch 21. When the select switch 21 is on, an input signal of the select switch 21 is transmitted to the signal processing unit 9. When the select switch 21 is off, an input signal of the select switch 21 is not transmitted to the signal processing unit 9.

As shown in FIG. 30, when a load applied to the mouse is smaller than the first predetermined load, the coil spring 4a is not compressed and the front of the mouse is lifted by the coil spring 4a. The coil spring 22a is not compressed and the front of the hand rest 22 is lifted by the coil spring 22a. Therefore, the cut off switch 13 and the select switch 21 are off. Since the cut off switch 13 is off, the power supply is not connected to the detecting unit 5 and power is not supplied to the detecting unit 5. In other words, the detecting unit 5 is in the invalid state. Since the select switch 21 is also off, a signal from the select switch 21 is not transmitted to the signal processing unit 9.

As shown in FIG. 31, when a load applied to the mouse is larger than the first predetermined load and smaller than the second predetermined load, the coil spring 4a is compressed, the bottom surface of the housing is made substantially parallel to the plane 7, and the distance between the bottom surface of the housing 1 and the plane 7 is set to h1. Since the coil spring 4a is compressed to press the push button of the cut off switch 13, the cut off switch 13 is on. Therefore, the power supply is connected to the detecting unit 5 and power is supplied to the detecting unit 5. Therefore, the detecting unit 5 is in the valid state in which the detecting unit 5 detects the movement of the mouse.

The coil spring 22a is not compressed and the front of the hand rest 22 is lifted by the coil spring 22a. Therefore, since the select switch 21 is off, a signal from the select switch 21 is not transmitted to the signal processing unit 9.

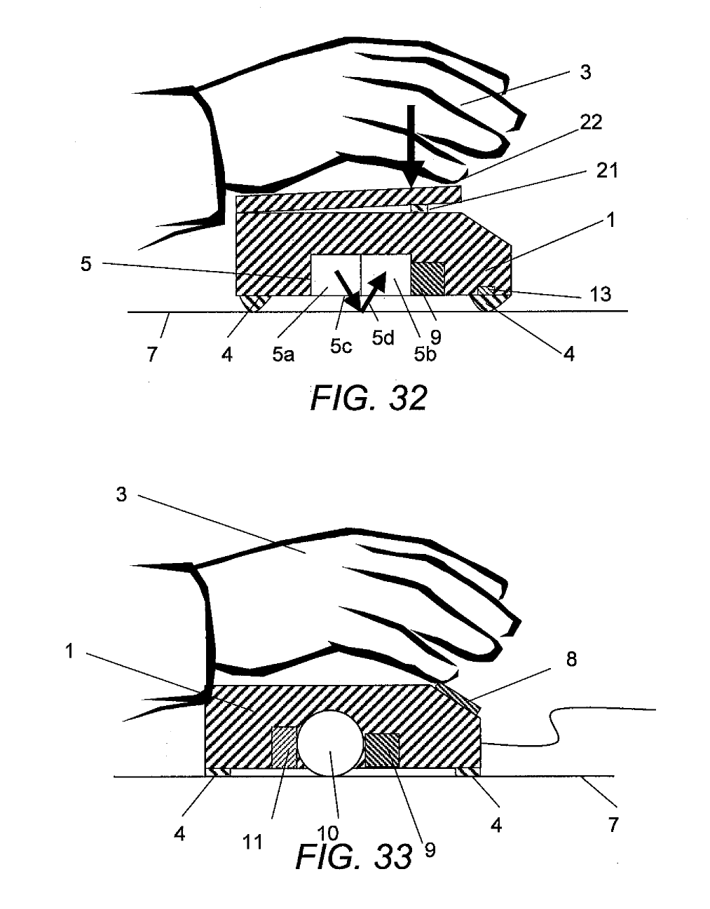

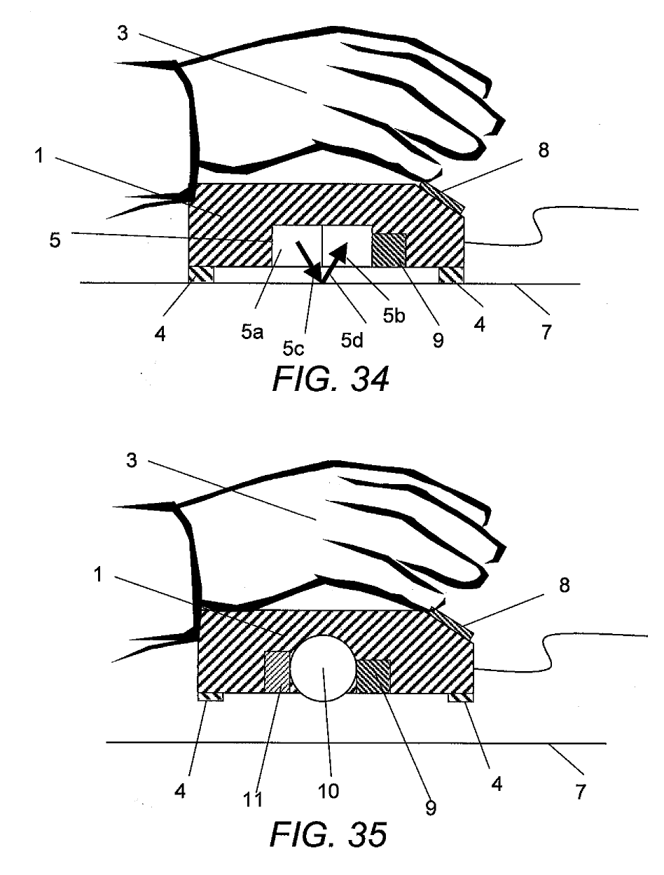

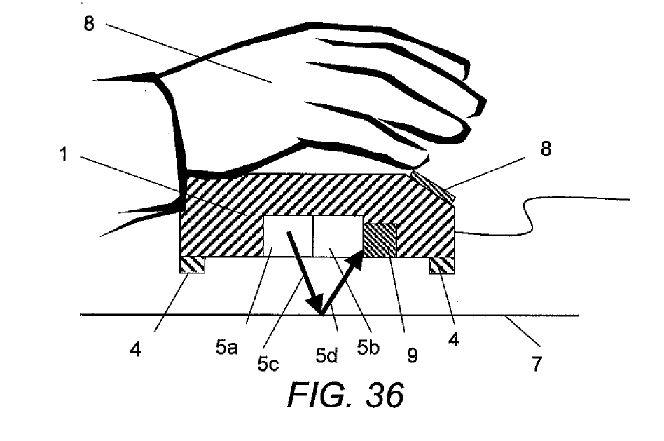

As shown in FIG. 32, when the second predetermined load larger than the first predetermined load is applied to the mouse, the coil spring 4a is kept compressed and the distance between the bottom surface of the housing 1 and the plane 7 continues to be h1. Since the coil spring 4a is kept compressed and presses the push button of the cut off switch 13, the cut off switch 13 is on. Therefore, the power supply is connected to the detecting unit 5 and power is supplied to the detecting unit 5. Therefore, the detecting unit 5 is in the valid state in which the detecting unit 5 detects the movement of the mouse.

The coil spring 22a is compressed and the push button of the select switch 21 is pressed by the hand rest 22. Therefore, the select switch 21 is turned on and a signal is transmitted from the select switch 21 to the signal processing unit 9.

The first predetermined load only has to be set to a load substantially equivalent to the own weight of the hand. Therefore, the second predetermined load is a predetermined load larger than the own weight of the hand.

In the eleventh embodiment, it is possible to switch between the valid state and the invalid state of the detecting unit 5 according to whether the own weight of the hand is applied to the mouse. This makes it unnecessary for the user to lift the mouse and move the mouse with lifting. Thus, it is possible to provide a mouse that has high operability for people with a low degree of freedom of hands and fingers. It is also possible to provide a mouse that does not impose burdens on a wrist and fingers.

When the second predetermined load larger than the own weight of the hand is applied to the mouse, the select switch 21 is inputted, so it is possible to provide a mouse that has high operability for people with a low degree of freedom of hands and fingers. It is also possible to provide a mouse that does not impose burdens on a wrist and fingers.

A spring constant of the coil spring 4a is set smaller than a spring constant of the coil spring 22a, so it is possible to turn on the select switch 21, or input the select switch 21, while keeping the detecting unit 5 in the valid state. Thus, it is possible to perform operation of so-called click-and-drag.

While the present invention has been described in detail and pictorially in the accompanying drawings, the present invention is not limited to such detail but covers various obvious modifications and equivalent arrangements, which fall within the purview of the appended claims.

What is claimed is:

1. A coordinate pointing device, comprising:
a detecting unit for detecting movement of a main body of the coordinate pointing device;
a signal processing unit for outputting a coordinate input signal based on information detected by the detecting unit; and
switching means for switching a valid state in which the detecting unit detects the movement of the main body of the coordinate pointing device and an invalid state in which the detecting unit does not detect the movement of the main body.

2. The coordinate pointing device according to claim 1, wherein:
the coordinate pointing device comprises an elastic portion; and
when the elastic portion is compressed, the switching means switches to the valid state.

3. The coordinate pointing device according to claim 2, wherein:
the detecting unit comprises a light emitting unit for emitting light and a light receiving unit for receiving light emitted by the light emitting unit;
the elastic portion urges one of a front of the coordinate pointing device and a rear of the coordinate pointing device in a direction in which the coordinate pointing device becomes apart from the plane; and
when a predetermined load is applied to the elastic portion, the coordinate pointing device is located in a position where the light emitted by the light emitting unit is reflected on the plane and made incident on the light receiving unit, to thereby cause the switching means to switch to the valid state.

4. The coordinate pointing device according to claim 2, wherein:
the detecting unit comprises a ball capable of rotating on the plane and a motion sensor for detecting rotation of the ball;
the elastic portion urges one of a front of the coordinate pointing device and a rear of the coordinate pointing device in a direction in which the coordinate pointing device becomes apart from the plane; and
when a predetermined load is applied to the elastic portion, the coordinate pointing device is located in a position where the ball comes into touch with the plane, to thereby cause the switching means to switch to the valid state.

5. The coordinate pointing device according to claim 1, wherein the switching means includes a switch for switching the valid state and the invalid state.

6. The coordinate pointing device according to claim 5, wherein:
the coordinate pointing device comprises the switch on a bottom surface side opposed to the plane; and
a load is applied to the cut off switch via the coordinate pointing device.

7. The coordinate pointing device according to claim 5, wherein the switch switches the valid state in which power is supplied to the detecting unit and the invalid state in which the supply of power to the detecting unit is interrupted.

8. The coordinate pointing device according to claim 3,
wherein the switching means includes a switch for switching the valid state and the invalid state.
wherein the switch switches the valid state in which power is supplied to the light emitting unit and the invalid state in which the supply of power to the light emitting unit is interrupted.

9. The coordinate pointing device according to claim 5, wherein the switch switches the valid state in which the detecting unit is connected to the signal processing unit and the invalid state in which the connection between the detecting unit and the signal processing unit is interrupted.

10. The coordinate pointing device according to claim 5, wherein, in the invalid state, the signal processing unit outputs a stop signal for invalidating the movement detected by the detecting unit.

11. The coordinate pointing device according to claim 1, wherein:
when a first predetermined load is applied to the coordinate pointing device, the switching means switches the valid state; and
when a second predetermined load larger than the first predetermined load is applied to the coordinate pointing device, the detecting unit transmits an operation signal indicating pointing operation by the coordinate pointing device to the signal processing unit.

12. The coordinate pointing device according to claim 11, wherein:
the detecting unit comprises a light emitting unit for emitting light and a light receiving unit for receiving the light emitted by the light emitting unit;
the coordinate pointing device comprises an elastic portion for urging a front of the coordinate pointing device in a direction in which the coordinate pointing device becomes apart from the plane;
the switching means includes a switch for switching the valid state and the invalid state; and
when a first predetermined load is applied to the coordinate pointing device, the coordinate pointing device is located in a position where the light emitted by the light emitting unit is reflected on the plane and made incident on the light receiving unit and the switch switches to the valid state in which power is supplied to the detecting unit.
